(19) United States
(12) Patent Application Publication
(10) Pub. No.: US 2018/0029948 A1
(43) Pub. Date: Feb. 1, 2018

(54) FOOD WASTE RECYCLER WITH MIXING ASSEMBLY

(71) Applicant: Whirlpool Corporation, Benton Harbor, MI (US)

(72) Inventors: Wade Alan Atkinson, Benton Harbor, MI (US); Thomas A. Latack, Baroda, MI (US); Joseph Gregory, Benton Harbor, MI (US); Michael A. Weston, Lawrence, MI (US)

(21) Appl. No.: 15/220,510

(22) Filed: Jul. 27, 2016

(51) Int. Cl. C05F 17/02

(52) U.S. Cl. CPC C05F 17/0205

(57) ABSTRACT

The disclosure relates to a food waste recycler including a housing defining an interior with an access opening providing access to the interior, a bin located within the interior and a mixing assembly located within the bin to facilitate the movement of material, such as refuse, according to an automatic cycle of operation.

### BACKGROUND

Food waste recyclers are known to implement a composting cycle for biologically and chemically decomposing organic material, such as food waste and other refuse, into compost for use as a fertilizer and soil amendment. The composting cycle can be implemented in a composting bin by providing water, heat and aeration to the refuse, and can require a period of time for completion.

The composting bin is capable of holding about seven days of refuse, and contains a mixing assembly to facilitate material movement. The movement of material promotes effective mechanical breakdown and aerates the refuse to prevent anaerobic decomposition, and promotes drying of the refuse through the processing cycle. Additionally, the mixing assembly facilitates material movement at the bottom of the bin to aid in transfer of refuse out of the bin.

### BRIEF SUMMARY

In one aspect the present innovation relates to, a food waste recycler for composting refuse according to an automatic cycle of operation, the food waste recycler comprising a housing, a bin located within the housing and defining an inner surface, a heater thermally coupled to the waste container, a motor located within the housing, and a stirrer, located in the bin and having a shaft coupled to the motor, an auger extending about the shaft, and a skimming wand extending from the shaft and located adjacent, but not in contact, with the inner surface, wherein the motor rotates the shaft to rotate the auger, which mixes waste within the bin, and rotates the skimming wand, which moves near the inner surface to dislodge waste attached to the inner surface without scraping the inner surface.

In another aspect, a stirrer for a bin having an inner surface in a food waste recycler, the stirrer comprising a shaft, an auger extending about the shaft, and a skimming wand extending from the shaft and located adjacent, but not in contact, with the inner surface.

### BRIEF DESCRIPTION OF THE DRAWINGS

In the drawings:

FIG. 1 is a perspective view of a food waste recycler including a bin with a stirrer.

FIG. 2 is a block diagram of a control system of the food waste recycler.

FIG. 3 is side view of the bin and stirrer of the food waste recycler with the housing removed for clarity.

FIG. 4 is top view of the bin of FIG. 3.

FIG. 5 is a side view of the stirrer of the food waste recycler.

FIG. 6 is a side view of another embodiment of the stirrer of the food waste recycler.

FIG. 6A is a schematic top view of the stirrer of FIG. 6.

### DETAILED DESCRIPTION

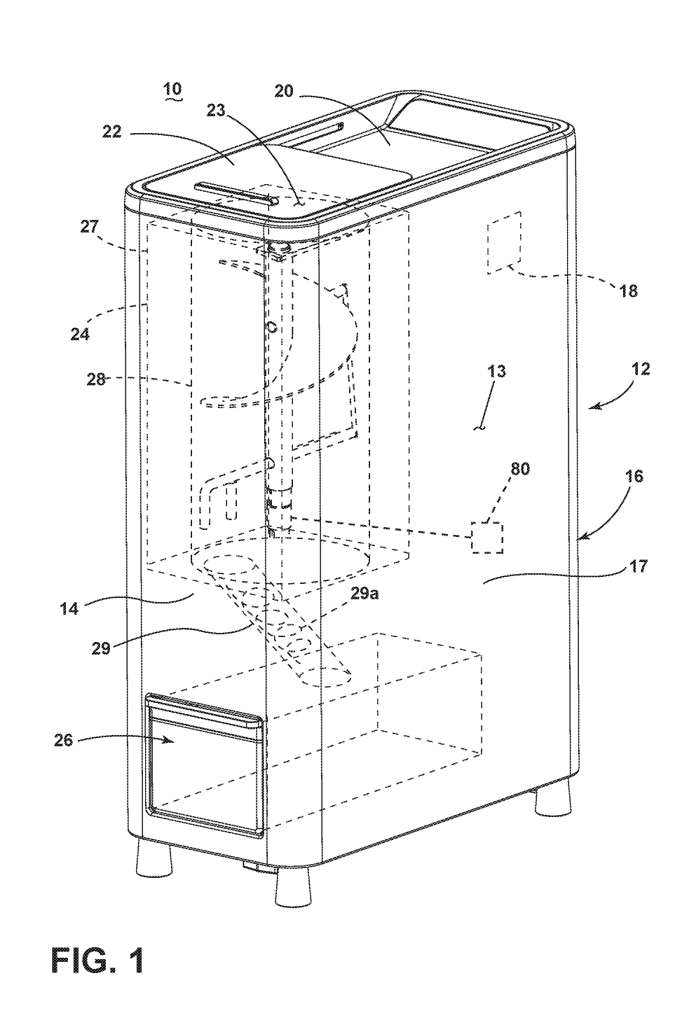

FIG. 1 illustrates a perspective view of a food waste recycler 10 or a food recycler oriented in the vertical direction for transforming organic material into compost by way of a composting cycle of operation. The food waste recycler 10 can include a housing 12 defining an interior 13 having a front wall 14 spaced from a back wall 16, a pair of side walls 17, and a controller 18 located within the housing 12.

A top wall 20 can enclose the housing 12 at the top of the front wall 14, back wall 16, and the pair of side walls 17. The housing 12 can be any structure for enclosing, supporting and protecting the electrical and mechanical components of the food waste recycler 10 including, but not limited to a cabinet with a frame.

The top wall 20 can include a cover 22 slidably mounted to a portion of the top wall 20 for sliding movement between open or closed positions to enable access to interior components of the food waste recycler 10. The cover 22 can be any barrier that provides selective access to a fill opening 23 for inputting organic material into the food waste recycler 10, including, but not limited to a hingedly, slidably or removably mounted door, drawer, panel or lid. While shown in FIG. 1 as coupled to the top wall 20, the cover 22 can be mounted to any exterior wall enclosing the housing 12 including, but not limited to the front wall 14. The top wall 20, as well as the remainder of the housing 12, can be formed of any material suitable for construction of the housing structure including, but not limited to metal such as steel or steel alloy, plastic, composite materials such as a hardened polymer composite material and combinations thereof. Some models of food waste recyclers 10 can include decorative panels that can be mounted on the housing 12 or one or more walls.

When in the open position, the cover 22 provides access to the interior 13 of the housing 12. In the open position, the cover 22 can further expose any element of the interior 13 including but not limited to one or more water fill inlets for supplying water to the food waste recycler 10 and one or more enzyme dispenser inlets. A bin 24 is provided within a bin housing 27. The bin 24 can be disposed beneath the cover 22 such that the cover provides selective access to the bin 24 as the cover is opened/closed. While the bin 24 is illustrated as a composting bin, it is also contemplated that the bin 24 is a temporary storage bin for accumulating refuse prior to a composting cycle.

The bin 24 further comprises a mixing assembly having a stirrer 28, which includes a shaft 30 mounting an auger 32 and a skimming wand 34. A conduit 29 can extend from the bin 24, such as from a lower portion of the bin 24, toward an access drawer 26. Embodiments of the disclosure can optionally include a transfer mechanism 29a disposed inside the conduit 29 capable of assisting the transfer of material from the bin 24 to the access drawer 26. Examples of a transfer mechanism can include, but are not limited to, a rotatable auger, a conveyor, a gravitational chute, and the like.

The access drawer 26 is provided and slides in or out through an opening in the front wall 14. The access drawer 26 is a drawer slidably mounted to the housing 12 on a horizontal axis for movement between open and closed positions. It will be understood, however, that access to the interior 13 of the food waste recycler 10 via the front wall 14 can be provided in other ways, including but not limited to, a door pivotally connected to the front wall 14. The access drawer can be detachably mounted to an internal side of the housing 12 and is accessible from outside the housing 12. The access drawer 26 can be removable from the interior 13 of the housing 12 so that the contents thereof can be discharged at will by a user, as for example, by dumping the contents of the drawer 26 onto a garden. The access drawer 26 can be located on any part of the housing 12 rather than the front wall 14.

A motor 80 can be provided inside the housing 12 and can be operatively coupled with the stirrer 28 by way of a belt or pulley system. The motor 80 can be a brushless permanent magnet (BPM) motor. Alternately, other motors such as an induction motor or a permanent split capacitor (PSC) motor can also be used.

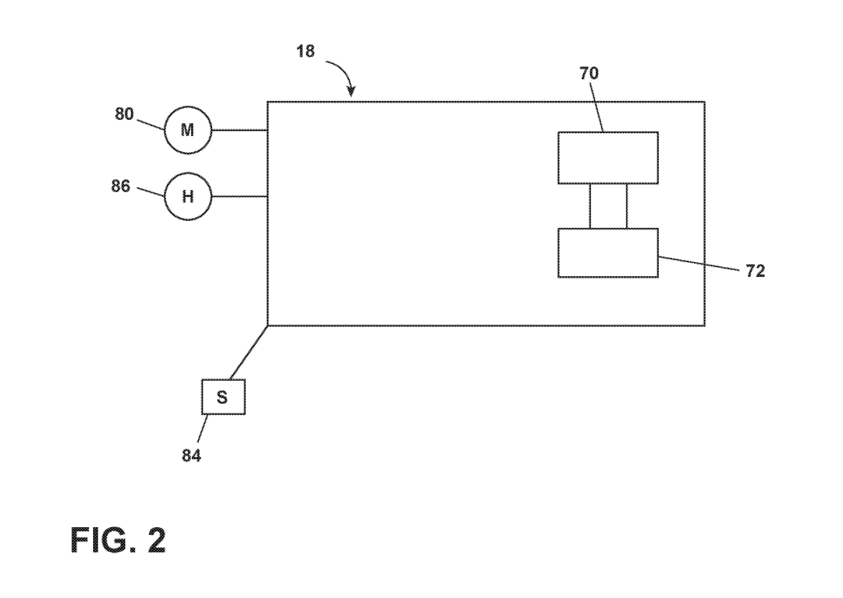

Referring now to FIG. 2, a schematic of the controller 18 for controlling the operation of the food waste recycler 10 is illustrated. The controller 18 can be provided with a memory 70 and a central processing unit (CPU) 72. The memory 70 can be used for storing the control software that is executed by the CPU 72 in completing a cycle of operation using the food waste recycler 10 and any additional software. The memory 70 can also be used to store information, such as a database or table, and to store data received from one or more components of the food waste recycler 10 that can be communicably coupled with the controller 18.

The controller 18 can be operably coupled with one or more components of the food waste recycler 10 for communicating with and controlling the operation of the component to complete a cycle of operation. For example, the controller 18 can be operably coupled with the motor 80 to control the operation of the motor 80. In another example, the controller 18 can be operably coupled to a heater 86. The controller 18 can also be coupled with one or more sensors 84 provided in one or more of the systems of the food waste recycler 10 to receive input from other sensors in the food waste recycler 10.

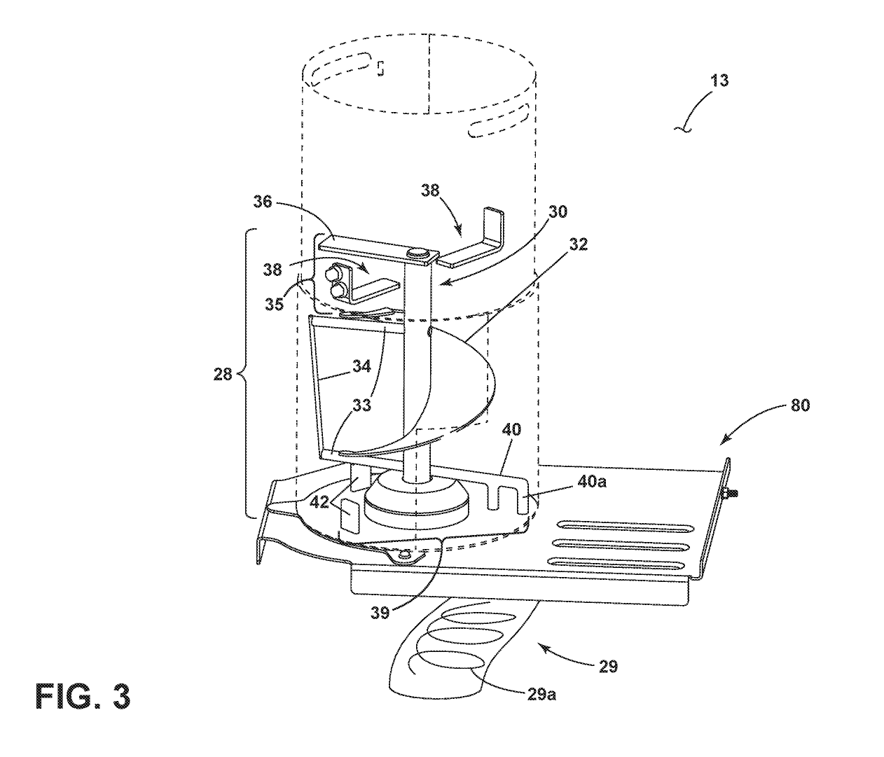

FIG. 3 illustrates details of the components of the mixing assembly of the food waste recycler 10 in a side view with the housing 12 removed for clarity. As is seen in FIG. 3, the mixing assembly comprises the bin 24, the motor 80, and the stirrer 28. The motor 80 can be configured to operate the mixing assembly at different speeds during the cycle of operation to facilitate the reducing or mixing of refuse in the bin 24 or the access drawer 26.

The stirrer 28 comprises the shaft 30, the auger 32, and the skimming wand 34. The shaft 30 extends from the bottom of the bin 24 towards the top, and is coupled to the motor 80 to operate, rotate, toggle, or actuate the stirrer 28. The auger 32 extends about the shaft 30 and may be in the form of a blade, or a flange, and may rotate, or wrap, around the shaft 30 in a spiral, helical, or other suitable shape.

The skimming wand 34 is mounted to the shaft 30 by means of the bars 33 or any other suitable approach such as directly mounting to the auger 32, and extends toward the bin 24. However, the skimming wand 34 does not contact the bin 24; instead, the skimming wand is spaced slightly from the bin to avoid direct contact between the skimming wand 34 and the inner surface 24a of the bin 24, which reduces wear between the two parts. The skimming wand may comprise a rod or a blade.

The stirrer 28 further comprises two choppers 35, 39. A first chopper 35 is located on an upper portion of the stirrer 28 and comprises a first blade 36 mounted to the shaft 30, and a second blade 38 mounted to an inner surface 24a of the bin 24. A second chopper 39 is located on the lower portion of the stirrer 28 and comprises a fork 40 having tines 40a, mounted to a bar 33 or any other suitable approach such as directly mounting to the auger 32, and projections 42 mounted to the bin 24 located in between the rotational path defined by the tines 40a.

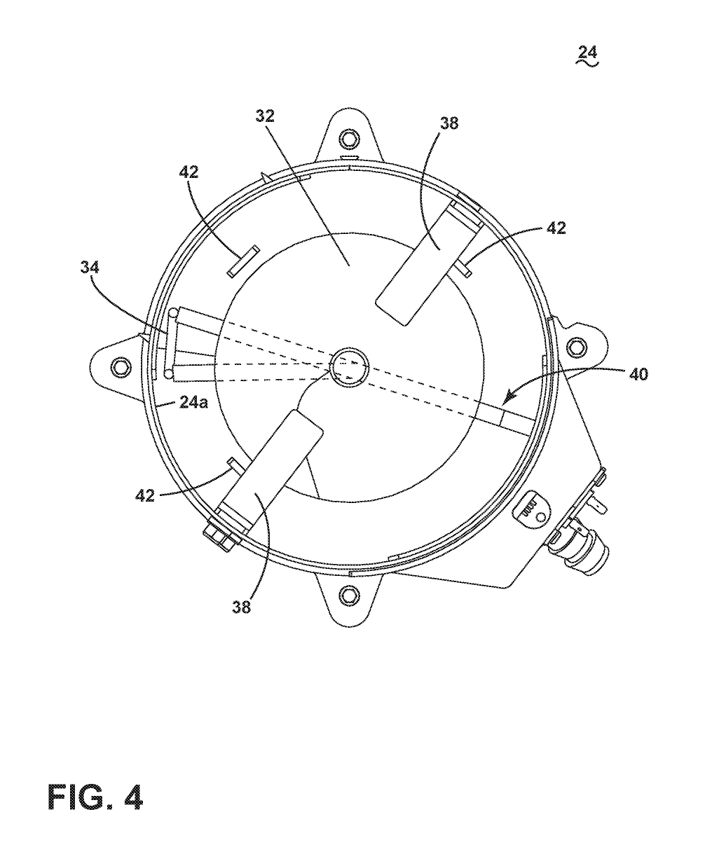

FIG. 4 is a top view of bin 24 in FIG. 3 in order to show in greater detail the projections 42 mounted to the bin 24, that are located in between the rotational path defined by the tines 40a. FIG. 4 also better illustrates the skimming wand 34, which is spaced very closely to the inner surface 24a of the bin 24, without touching the inner surface 24a.

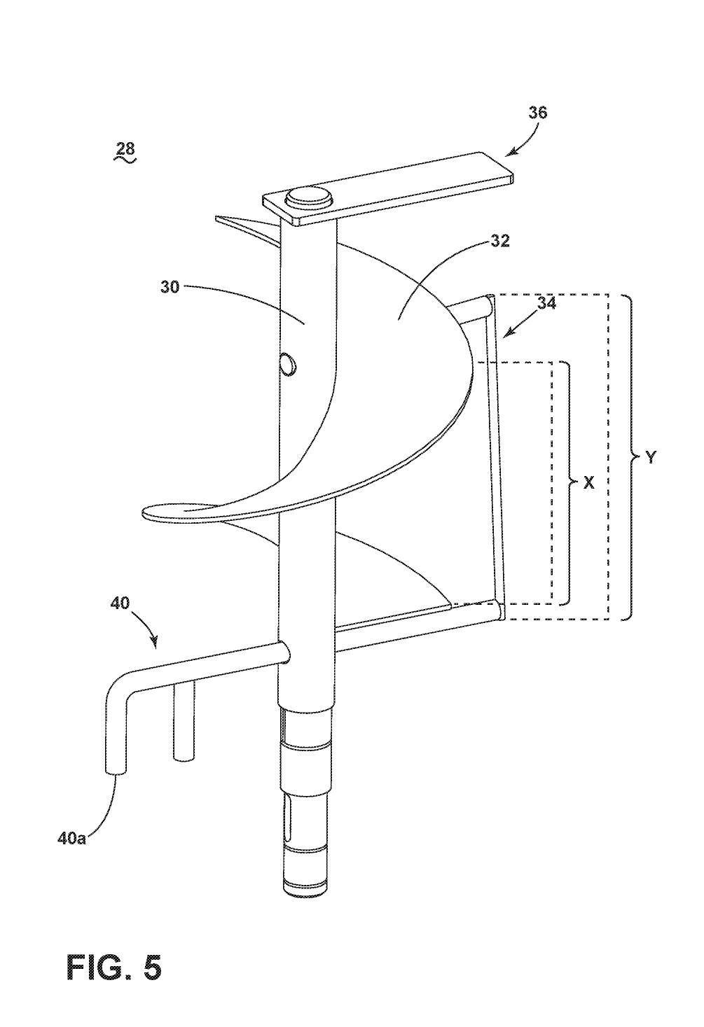

Turning to FIG. 5, the stirrer 28 is shown without the bin 24. While illustrated as wrapping around the shaft for multiple revolutions, the auger 32 can wrap around the shaft for less than or more than one revolution. It is also contemplated that the auger 32 does not continuously wrap around the shaft 30, wherein the auger comprises a plurality of segments that wrap around the shaft 30. The skimming wand 34, like the auger, may rotate, or wrap, around the shaft 30 for less than one revolution and/or more than one revolution. The distance of the crest of the auger 32 to the next crest or the auger 32 (a complete revolution) defines pitch X of the auger 32. Likewise, the distance of the crest of the skimming wand 34 to the next crest of the skimming wand 34 defines the pitch Y of the skimming wand 34. As seen in FIG. 4, the skimming wand 34 makes less than ⅛ of a revolution around the shaft 30. In this embodiment, the pitch X of the auger 32 is less than the pitch of the skimming wand 34 since the vertical distance of pitch X in a complete revolution is less than the vertical distance than pitch Y of skimming wand 34 in less than ⅛ of a revolution.

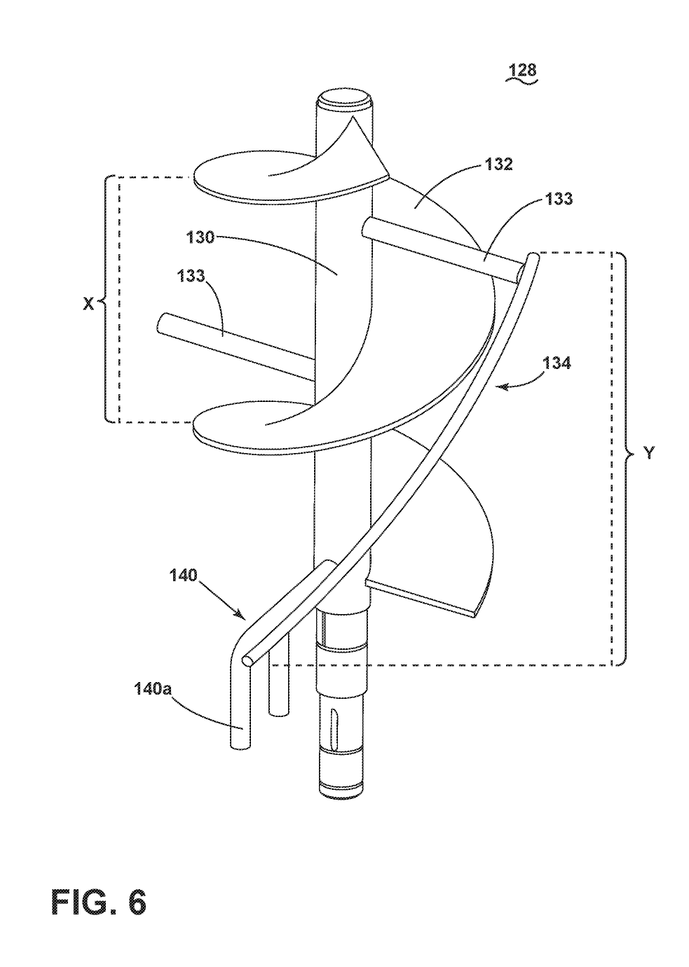

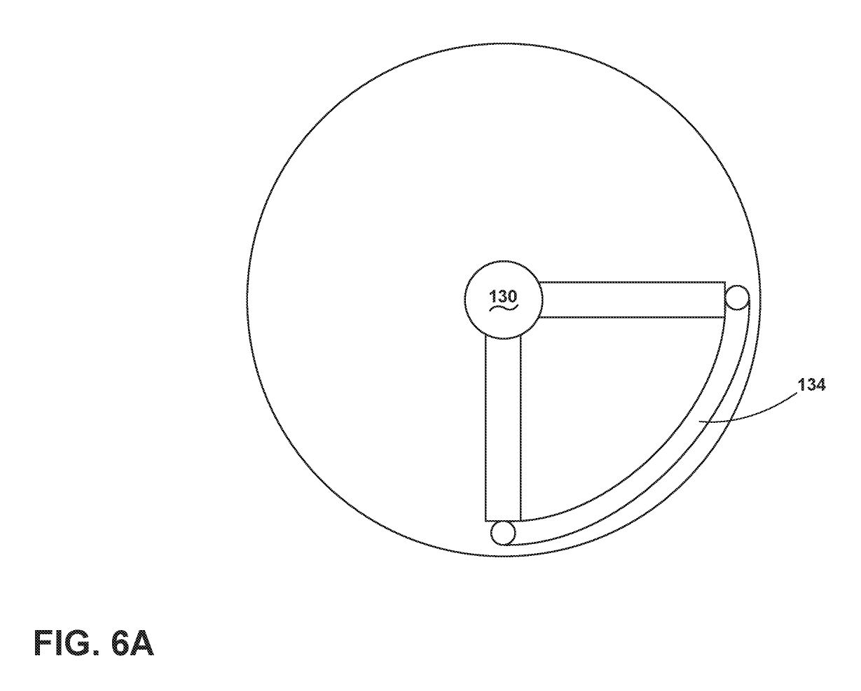

An alternative embodiment of a stirrer is illustrated in FIG. 6. This embodiment is similar to the first embodiment, therefore, like parts are identified with like numerals increasing by 100, with it being understood that the description of the like parts of the first embodiment applies to the additional embodiment, unless otherwise noted. In this embodiment, the skimming wand 134 is mounted to the shaft by means of a bar 133 and a fork 140. Also, the pitch X of the auger 132 and the pitch Y of the skimming wand 134 are less than the pitch X of the auger 32 and the pitch of the skimming wand 34 illustrated in FIG. 4. The skimming wand 134 of FIG. 6 is shown in FIG. 6A making about ¼ of a revolution around the shaft 130. Since the pitch Y of skimming wand 134 is less than double that of pitch Y of skimming wand 34 of FIG. 5, the pitch Y of skimming wand 134 is less than pitch Y of skimming wand 34.

An example of a complete cycle of operation can include receiving organic material into the bin 24, mixing the refuse within the bin 24 while simultaneously drying the refuse and then transferring the refuse to the access drawer 26 after which the composted refuse can be removed.

More specifically, operation of the stirrer 28 can include rotating, toggling, or actuating the stirrer 28. Upon operation of the stirrer 28, the auger 32 mixes the refuse in the bin 24. The bin 24 may be a mixing container and/or a composting container where the refuse is mixed and/or composted. Simultaneously, the skimming wand 34 moves near the inner surface 24a of the bin 24 to dislodge refuse attached to the inner surface 24a without scraping the inner surface 24a. The skimming wand 34 also helps to move refuse vertically. In addition, the choppers 35, 39, interact to comminute refuse in the bin 24. The choppers can be can be spaced apart relative to the stirrer and located on an upper and/or lower portion of the stirrer 28. A chopper located at the lower portion of the stirrer 28, such as chopper 39, can keep refuse from settling at the bottom of the bin 24, and prevent the formation of a crust. Also, chopper 39 may aid in transfer of material outside of the bin 24 through conduit 29 to access drawer 26.

To the extent not already described, the different features and structures of the various embodiments can be used in combination with each other as desired. That one feature cannot be illustrated in all of the embodiments is not meant to be construed that it cannot be, but is done for brevity of description. Thus, the various features of the different embodiments can be mixed and matched as desired to form new embodiments, whether or not the new embodiments are expressly described. Combinations or permutations of features described herein are doored by this disclosure.

This written description uses examples to disclose embodiments of the invention, and also to enable any person skilled in the art to practice embodiments of the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A food waste recycler for composting refuse according to an automatic cycle of operation, the food waste recycler comprising:
a housing;
a bin located within the housing and defining an inner surface;
a heater thermally coupled to a waste container;
a motor located within the housing; and
a stirrer located in the bin and having a shaft coupled to the motor, an auger extending about the shaft, and a skimming wand extending from the shaft and located adjacent, but not in contact, with the inner surface;
wherein the motor rotates the shaft to rotate the auger, which mixes waste within the bin, and rotates the skimming wand, which moves near the inner surface to dislodge refuse attached to the inner surface without scraping the inner surface.

2. The food waste recycler of claim 1 wherein the bin is a mixing container where the refuse is mixed.

3. The food waste recycler of claim 1 wherein the bin is a composting container where the refuse is composted.

4. The food waste recycler of claim 1 wherein the auger comprises a blade.

5. The food waste recycler of claim 4 wherein the blade has at least one of a spiral or helical shape.

6. The food waste recycler of claim 1 wherein the skimming wand comprises at least one of a rod or blade.

7. The food waste recycler of claim 1 wherein the auger has a first pitch and the skimming wand had a second pitch, which is less than the first pitch.

8. The food waste recycler of claim 1 wherein the auger wraps around the shaft for at least one revolution and the skimming wand wraps around the shaft for less than one revolution.

9. The food waste recycler of claim 8 wherein the skimming wand wraps around the shaft for less than ⅛ revolution.

10. The food waste recycler of claim 1 further comprising at least one chopper having a first element mounted to the stirrer and a second element mounted to the bin, wherein the first and second elements interact to comminute refuse in the bin.

11. The food waste recycler of claim 10 further comprising at least two choppers, which are spaced apart relative to the stirrer.

12. The food waste recycler of claim 11 wherein one of the at least two choppers is located on an upper portion of the stirrer and the other of the at least two choppers is located on a lower portion of the stirrer.

13. The chopper of claim 10 wherein the first and second elements are blades.

14. The chopper of claim 10 wherein the first element is a fork having tines, and the second element is a projection located in between a rotational path defined by the tines.

15. A stirrer for a bin having an inner surface in a food waste recycler, the stirrer comprising:
a shaft;
an auger extending about the shaft; and
a skimming wand extending from the shaft and located adjacent, but not in contact, with the inner surface.

16. The stirrer of claim 15 wherein the auger comprises a blade.

17. The stirrer of claim 16 wherein the blade has at least one of a spiral or helical shape.

18. The stirrer of claim 15 wherein the skimming wand comprises at least one of a rod or blade.

19. The stirrer of claim 15 wherein the auger has a first pitch and the skimming wand had a second pitch, which is less than the first pitch.

20. The stirrer of claim 15 wherein the auger wraps around the shaft for at least one revolution and the skimming wand wraps around the shaft for less than one revolution.
